(19) United States
(12) Patent Application Publication
(10) Pub. No.: US 2005/0046356 A1
(43) Pub. Date: Mar. 3, 2005

(54) Lighting apparatus for generating anions and purifying air

(76) Inventor: Donovan Dongsoon Kwak, Gyeonggi-do (KR)

Correspondence Address: Diane Dunn McKay, Esq.;Mathews, Collins, Shepherd & McKay, P.A., Suite 306, 100 Thanet Circle, Princeton, NJ, 08540, US

(21) Appl. No.: 10/826,750

(22) Filed: Apr. 16, 2004

(30) Foreign Application Priority Data
Sep. 3, 2003 (KR) 2003-61398

(51) Int. Cl. H01K 1/62

(52) U.S. Cl. 315/55

(57) ABSTRACT

A lighting device for preventing generation of ozone, which is an air pollutant, while generating anions and purifying air is disclosed. The lighting apparatus has lamps mounted on an upper part thereof, adapted to emit light of three wavelengths, and a socket coupled to a lower part thereof. The lighting apparatus comprises an anion generator centrally mounted on the upper part of the housing, and a metal fiber brush mounted in the anion generator. The anion generator has a coating layer coated with titanium dioxide serving as a photocatalyst so as to perform air purification. The brush includes numerous metal fibers. Each of the metal fibers is formed on an outer surface thereof with numerous tiny projections. Each of the projections has a sharp tip. The lighting apparatus purifies air, without a UV lamp, using light of three wavelengths of the lamp, by coating the outer surface of the anion generator with the photocatalyst. The lighting apparatus does not generate ozone because it uses the metal fiber brush. The lighting apparatus prevents anions generated from the anion generator from being removed by electromagnetic interference.

### BACKGROUND OF THE INVENTION

1. Field of the Invention

The present invention relates to a lighting apparatus for generating anions and purifying air, and more particularly to a lighting device for preventing generation of ozone, which is an air pollutant, while generating anions and purifying air.

2. Description of the Related Art

Generally, in the present time, air pollution has worsened daily due to the increase of pollutants, resulting in environmental pollution, such as molds (i.e. fungus), various bacteria, car exhaust, and so on.

Thus, demand for an anion generator and an air purifier, so as to purify the air pollutants, has increased rapidly.

Air purifiers circulated in the market use a separate air blower for performing convection of the air in a room. The air blower is driven by a driving unit, such as a motor. However, the air blower occupies a large space within the air purifier. For this reason, in the case of an air purifier having a large capacity, there is a problem that the air blower must be separately installed and maintained.

Further, in the prior art, Korean Patent application Nos. 2001-0018937 and 2001-0071131 disclose lighting apparatuses for generating anion or purifying the air. Such an apparatus comprises a housing having an electrode for receiving electric power from an external power source and at least one lamp, an amplifier mounted within the housing and adapted to generate high voltage, and an anion generator centrally projected from an upper surface of the housing such that it is surrounded by the lamp. The anion generator receives the high voltage and generates anion. The anion generator serves to generate anions and purify air in a room.

Although most conventional lighting apparatuses use an anion generator utilizing traditional spark discharge, as in the above case, they generate an insufficient amount of anions. Moreover, a very small amount of ozone is generated.

### SUMMARY OF THE INVENTION

Therefore, the present invention has been made in view of the above problems, and it is an object of the present invention to provide a lighting apparatus for purifying the air, without a UV lamp, using light of three wavelengths of a lamp, by coating an outer surface of an anion generator with a photocatalyst.

It is another object of the present invention to provide a lighting apparatus which does not generate ozone by using a metal fiber brush.

It is yet another object of the present invention to provide a lighting apparatus for preventing anions generated from an anion generator from being removed by electromagnetic interference.

In accordance with the present invention, the above objects can be accomplished by the provision of a lighting apparatus having lamps mounted on an upper part thereof and adapted to emit light of three wavelengths, and a socket coupled to a lower part thereof, the lighting apparatus comprising, an anion generator centrally mounted on the upper part of the housing, the anion generator having a coating layer coated with titanium dioxide serving as a photocatalyst so as to perform air purification, and a metal fiber brush mounted in the anion generator, the brush including numerous metal fibers, each of the metal fibers being formed on an outer surface thereof with numerous tiny projections, each of the projections having a sharp tip.

### BRIEF DESCRIPTION OF THE DRAWINGS

The above and other objects, features and other advantages of the present invention will be more clearly understood from the following detailed description taken in conjunction with the accompanying drawings, in which:

FIG. 1A is a perspective view showing a lighting device for generating anions according to a prior art;

FIG. 1B is a sectional view showing a lighting device for generating anions according to a prior art;

FIG. 2A is an exploded perspective view showing a lighting device for generating anions and purifying air according to the present invention;

FIG. 2B is a perspective view showing a lighting device for generating anions and purifying air according to the present invention;

FIG. 2C is a sectional view showing a lighting device for generating anions and purifying air according to the present invention;

FIG. 2D is a sectional view showing another embodiment according to the present invention;

FIG. 3 is a sectional view showing a principal part of a lighting device for generating anions and purifying air according to the present invention; and

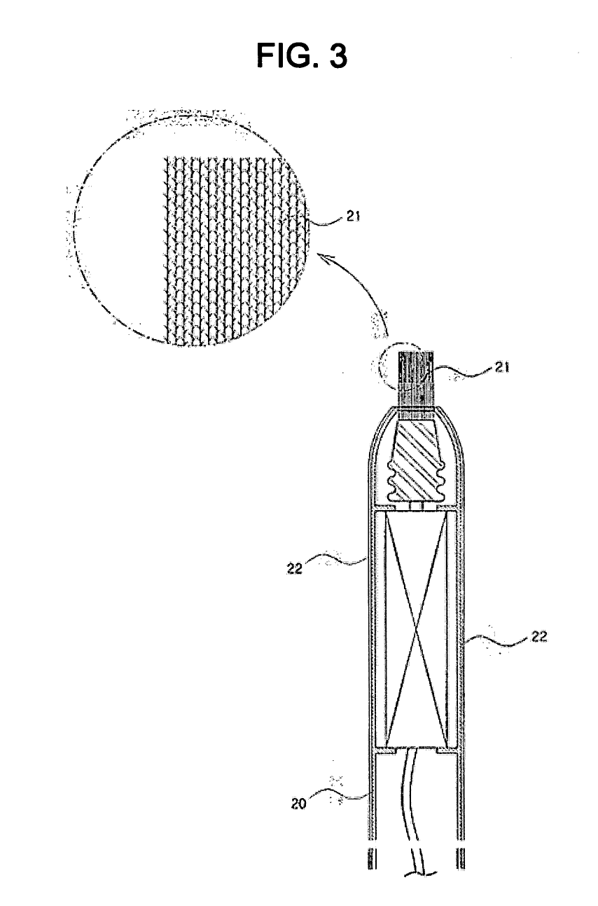

FIG. 4 is a circuit diagram of a lighting device for generating anions and purifying air according to the present invention.

### DESCRIPTION OF THE PREFERRED EMBODIMENTS

A conventional lighting apparatus will be described to provide a better understanding of the present invention hereinafter.

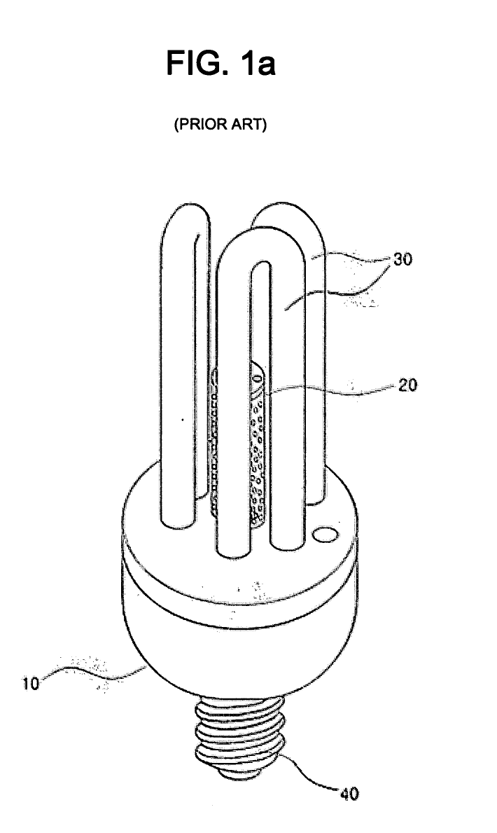

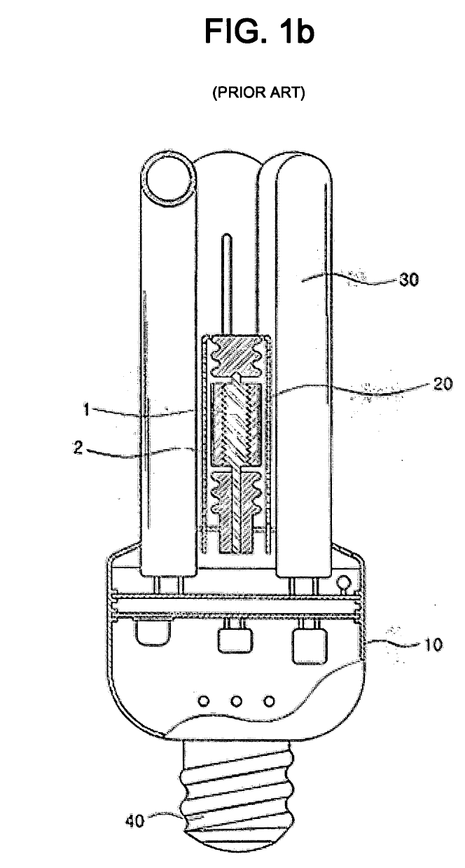

Referring to FIGS. 1A and 1B, the conventional lighting apparatus for generating anions comprises a cylindrical housing 10 including a plurality of lamps 30 mounted on a top thereof and a socket 40 attached to a bottom thereof, an amplifier fixedly supported by supporting members formed on an inner wall of the housing 10, an electric power supply connected to the socket 40 to apply electric power to the amplifier, and an anion generator 20 centerally mounted on the top of the housing 10. The anion generator 20 generates anions and has an aesthetically pleasing appearance.

Here, the amplifier receives electric power from the electric power supply, and amplifies it to a high voltage. The amplifier includes a transformer and other related electric components. The amplifier is fixedly supported by supporting members formed on an inner wall of the housing 10. The amplifier further includes an inverter supplying power to the lamp.

As described above, the anion generator 20 is mounted at the center of the top of the housing 10.

The anion generator 20 includes an anion generating plate 22, a plurality of electron guns 1, an electronic plate 2 having a plurality of holes and an anion collecting panel 3.

The anion generator 20 receives the high voltage from the amplifier and emits electrons to the electron guns 1 mounted within the anion generator 20.

At this time, the electrons discharged from the electron guns 1 strike against the electron plate and then generate anions. The generated anions are discharged to the outside of the housing 10 through the holes of the electronic plate 2.

Now, a lighting apparatus according to the present invention will be described in detail hereinafter.

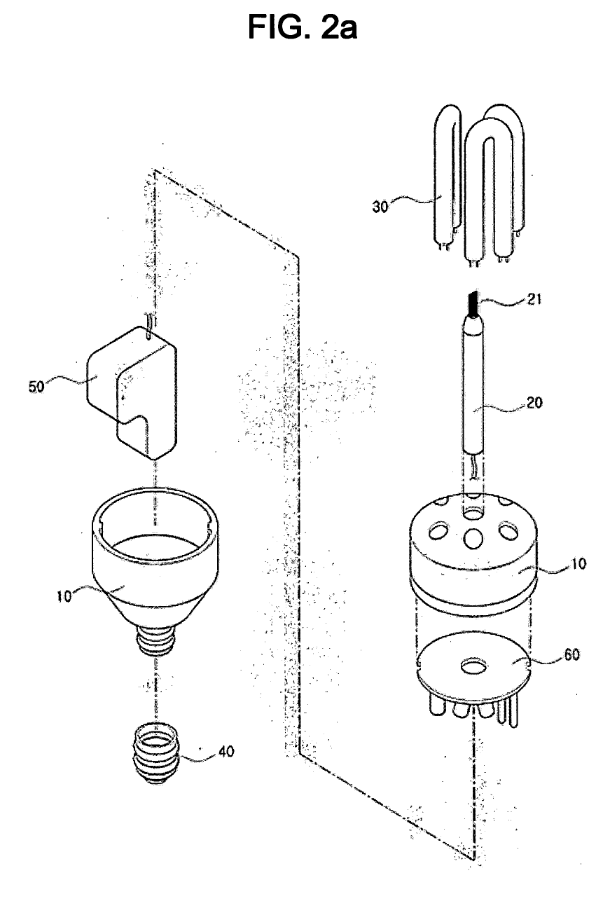

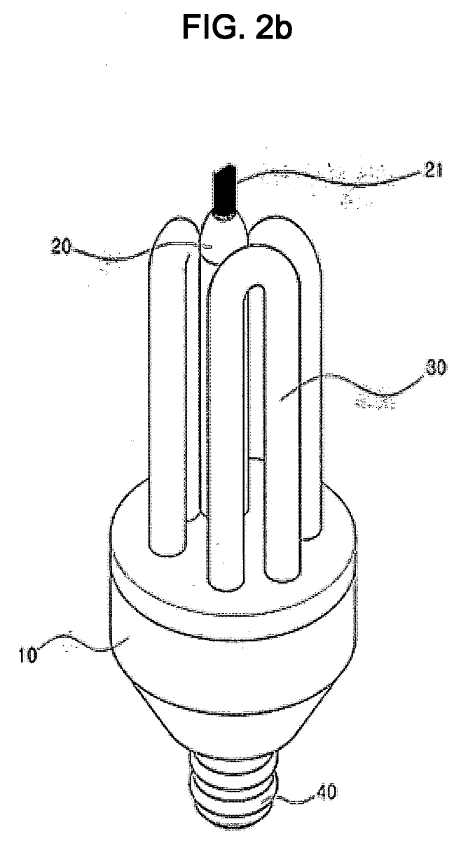

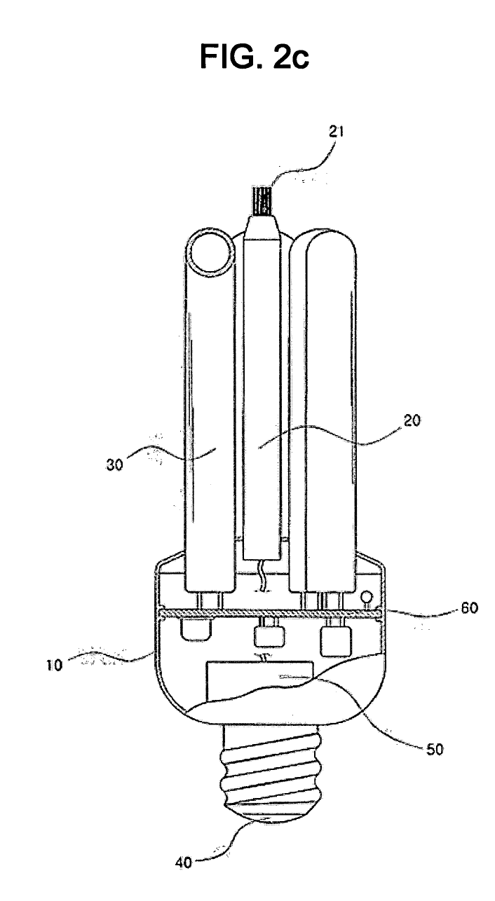

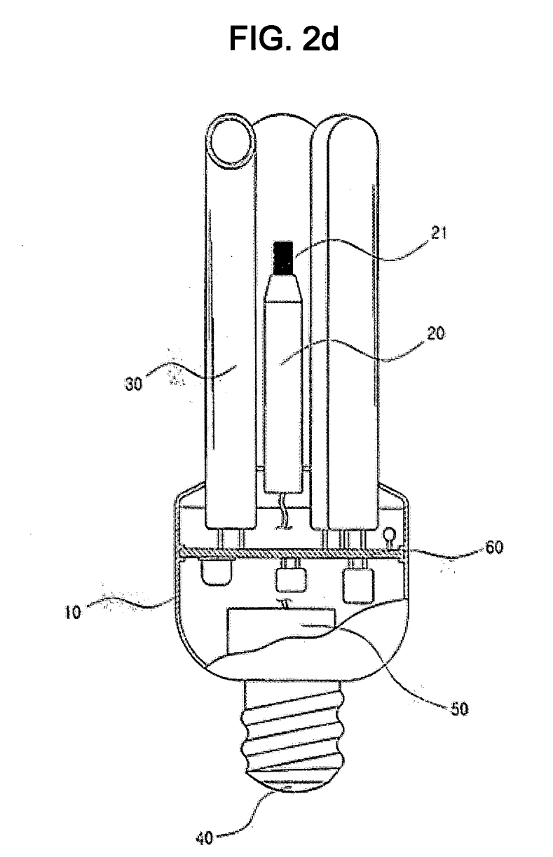

Referring to FIGS. 2A to 2D, the lighting apparatus according to the present invention comprises a cylindrical housing 10 consisting of an upper part and a lower part, an anion generator 20, a plurality of lamps 30 mounted on the upper part thereof, and an anion electric power source 50 engaged with a socket 40 within the lower part thereof. The anion electric power source 50 amplifies power and applies it to the anion generator 20. Further, the anion electric power source 50 is fixedly mounted within the upper part of the housing 10. The anion electric power source 50 is sealed within a case to prevent electromagnetic interference generated from the anion electric power source 50 from affecting a lamp electric power source 60 applying power to the lamps 30.

Here, the lamp electric power source 60 amplifies power or voltages received from the socket 40 into high voltages. The lamp electric power source 60 includes a transformer and other related electric components. Further, the lamp electric power source 60 is fixedly supported by supporting members formed on an inner wall of the housing 10.

Further, the anion generator 20 is centrally mounted on the upper part of the housing 10. The anion generator 20 has a coating layer coated with a photocatalyst such as titanium dioxide (TiO.sub.2) 22 to perform air purification, such as disinfection, deodorization, and so on. The lighting apparatus further comprises a metal fiber (MF3) brush 21 for generating anions without generating ozone. The brush 21 is mounted in the anion generator 20. The brush 21 has numerous metal fibers. Each of the metal fibers is formed on an outer surface thereof with numerous tiny projections. Each of the projections has a sharp tip. Preferably, the metal fibers may be made of a mixture of a conductive alloy made up of eight different metals with a conductive resin and a semi conductive resin.

Here, the titanium dioxide 22 serving as a photocatalyst is activated by light rays with three wavelengths generated from the lamps, so that it decomposes or dissolves organic or inorganic substances. That is, when the substances approach to or come in contact with the photocatalyst activated by the light rays, they are subjected to oxidation and/or reduction reactions, so that they are decomposed or dissolved by a photocatalyst effect.

Meanwhile, as described above, the conventional lighting apparatus comprises the lamps 30 mounted on the upper part of the housing 10, and the socket 40 coupled to the lower part of the housing 10. Further, in accordance with the configuration of the anion generator 20 including the electronic plate 2 having holes and the electronic guns 1, anions are discharged from the electronic guns 1 at high voltage. However, the anion generator 20 using the electronic guns 1 generates ozone, which is undesirable, in addition to anions.

In the lighting apparatus of the present invention, however, the anion generator 20 has the coating layer coated with the titanium dioxide 22, which is a photocatalyst, so as to perform air purification, such as disinfection, deodorization, and so on. Further, the lighting apparatus of the present invention comprises the metal fiber brush 21 generating anions without generating ozone. Thus, since the lighting apparatus of the present invention does not generate the air pollutants, such as ozone, and decomposes or dissolves organic substances in the air, it provides users with more purified air.

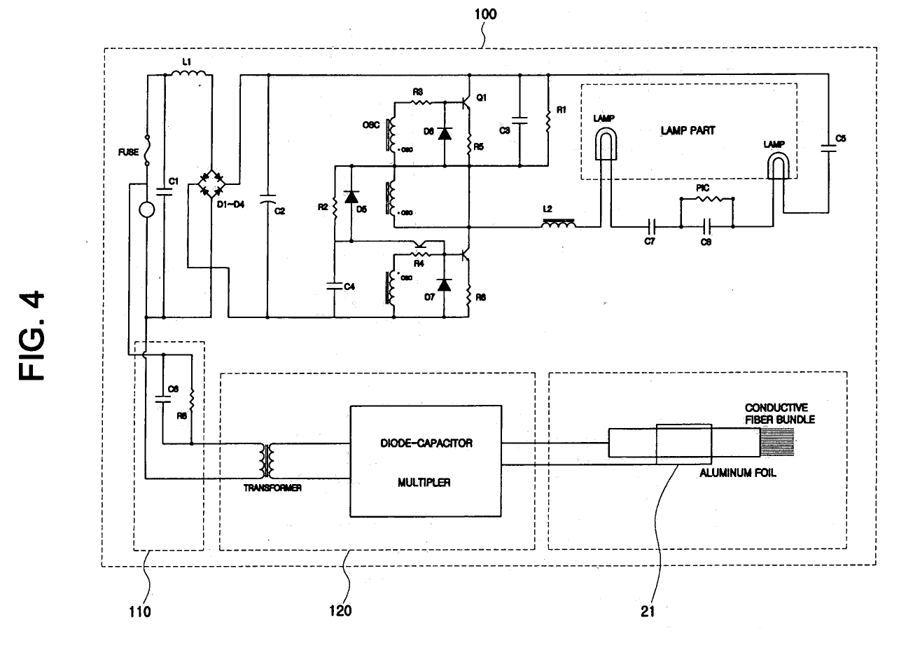

Referring to FIG. 4, the lighting apparatus of the present invention comprises a circuit for receiving AC electric power, rectifying the AC electric power into DC electric power, applying the DC electric power to a ballast, and performing amplification of voltage and supply of constant voltage, thereby turning on the lamps.

Further, the circuit includes an interference protection unit 110, an ion generation voltage induction unit 120, and the metal fiber brush 21. The interference protection unit 10 receives AC electric power, and prevents the ballast and the ion generator 20 from interfering with each other. The ion generation voltage induction unit 120 converts the AC electric power applied to the protection unit 110 into DC electric power of −5 KV, and generates pulses with a frequency multiplied by an integer ratio by a diode-capacitor multiplier. The metal fiber brush 21 receives current from the induction unit 120.

As apparent from the above description, the lighting apparatus of the present invention purifies the air, without a UV lamp, using light of three wavelengths of the lamp, by coating the outer surface of the anion generator with the photocatalyst. Further, the lighting apparatus does not generate ozone because it uses the metal fiber brush. Further, the lighting apparatus prevents anions generated from the anion generator from being removed by electromagnetic interference.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A lighting apparatus having lamps mounted on an upper part thereof and adapted to emit light of three wavelengths, and a socket coupled to a lower part thereof, the lighting apparatus comprising:
an anion generator centrally mounted on the upper part of the housing, the anion generator having a coating layer coated with titanium dioxide serving as a photocatalyst so as to perform air purification; and
a metal fiber brush mounted in the anion generator, the brush including numerous metal fibers, each of the metal fibers being formed on an outer surface thereof with numerous tiny projections, each of the projections having a sharp tip.

2. A circuit of a lightning apparatus having lamps for emitting light of three wavelengths to generate anions and purify the air, the circuit receiving AC electric power, the circuit comprising:
an interference protection unit for receiving the AC electric power and preventing the ballast and the ion generator from interfering with each other;
an ion generation voltage induction unit for converting the AC electric power applied to the interference protection unit into DC electric power of −5 KV and generating pulses with a frequency multiplied by an integer ratio by a diode-capacitor multiplier; and
a metal fiber brush for receiving current from the ion generation induction unit.
